(19) United States
(12) Patent Application Publication
(10) Pub. No.: US 2009/0184033 A1
(43) Pub. Date: Jul. 23, 2009

(54) Wood products having warp orientation indicia and methods for making the same

(75) Inventor: Michael A. George, Hot Springs, AR (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 12/018,571

(22) Filed: Jan. 23, 2008

(51) Int. Cl. B07C 5/14

(52) U.S. Cl. 209/518

(57) ABSTRACT

The method is provided that identifies warp orientation of a wood product in an automated or semi-automated process, and affixes the wood product with indicia that will assist the end user, such as a framing carpenter, a finish carpenter, a trim carpenter, etc., with improved wood product application, e.g., studs, beams, joists, molding, etc, and in-service placement. e.g., location and orientation. Wood products with warp orientation indicia are also provided.

### BACKGROUND

Warp stability is an increasingly important characteristic in wood products, especially in determining their end use. For example, new products emerging from dimension lumber, such as premium-grade joists and studs, require superior dimensional and warp stability performance to be accepted by the construction industry. Additionally, warp-prone lumber can be identified for use in only certain applications. For example, exterior window and door casings experience fluctuating moisture and temperature conditions during use. Warp prone lumber, even if initially straight when dried, could warp in such changing environments. Accordingly, using warp prone lumber in warp-inducing environments could be avoided. Moreover, extremely warp-prone wood may be suitable only for uses where warping is not a significant problem (e.g. for pallets, landscape applications, etc.).

Warp typically occurs in four orientations, which can be referred to as crook, bow, cup, and twist. Two of these types of warp, crook (also referred to as crown) and bow can be traced to differential length change within a board. Crook refers to in-plane, facewise curvature of wood relative to a longitudinal axis. Bow refers to in-plane facewise curvature relative to a longitudinal axis. Crook and bow are closely related and differ primarily according to the planar surface used to define the warp. Cup, on the other hand, refers to in-plane, facewise curvature of wood relative to a lateral axis. Twist, another type of warp, refers to a rotational instability about an axis of wood (usually the longitudinal axis). Twist is associated with varying grain angle pattern as described in U.S. Pat. No. 6,293,152, which is hereby incorporated by reference. Other forms of warp are influenced by a myriad of factors as described in U.S. Pat. Nos. 6,305,224, 6,308,571 and 7,017,413, which are hereby incorporated by reference.

In the construction industry, home builders and homeowners alike desire flat floors and straight walls. Typical construction uses dimension lumber to construct both the floors and walls. To achieve these results, dimension lumber with superior warp stability must be used, or the builder must try to use the lumber in a manner that attempts to minimize the affects of warp. If unsuccessful, inadequately fastened sheathing, etc. may occur.

For example, the builder attempts to position all pieces of lumber used to construct a wall, floor, etc. so that its warp orientation is aligned in the same direction. Currently, to achieve such results, the builder must 1) pick up the piece of lumber on-site; 2) sight along its length to establish the warp, e.g., crown, orientation; 3) mark or note the warp orientation; and 4) position the piece of lumber in the structure based on the warp orientation. This process takes significant time, management attention, and quality control effort.

Visual determination of warp orientation on-site may also not provide acceptable results in some applications. For example, some dimensional lumber may appear straight, i.e., may not visibly show its warp orientation, prior to use. However, when in service, such dimension lumber may experience warp as temperature and humidity fluctuate.

### SUMMARY

Embodiments of the present invention are directed to methods of identifying a predetermined characteristic in a wood product, e.g., the warp orientation characteristics of a piece of lumber, and appropriately affixing an indicia on the lumber as a result of, for example, the determined warp orientation. The indicia will instruct the builder on the appropriate use, e.g., stud, plate, etc. and orientation of the lumber, e.g. crown in, crown out, etc. Embodiments of the present invention are also directed to wood products having warp orientation indicia disposed thereon. Embodiments of the present invention may also determine other wood product attributes that may be indicated by the one or more indicia.

In accordance with aspects of the present invention, a wood product is provided. The wood product includes a body, and one or more indicia affixed to the body indicative of at least one warp orientation of the body. In several embodiments, the wood product is tested using various warp prediction techniques for determining at least warp orientation. The tests may obtain one or more measurements that are selected from a group consisting of moisture content measurement, electrical property measurement, structural property measurement, acousto-ultrasonic property measurement, light scatter or tracheid-effect measurement, grain angle measurement, shape measurement, color measurement, spectral measurement and defect maps. In these and other embodiments, the indicia is then selected in tight of the results of the tests and affixed to the appropriate portion of the wood product to convey the appropriate information to the end user.

In accordance with another aspect of the present invention, a method is provided for making a wood product having a warp orientation indicia. The method comprises obtaining a wood product having one or more surfaces, determining at least one wood product attribute associated with the wood product, and attaching one or more indicia to at least one of the one or more surfaces, at least one of the one or more indicia indicative of warp orientation.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a flow chart of one exemplary method of making a wood product having warp orientation indicia in accordance with aspects of the present invention;

FIGS. 2-9 are examples of wood product having one or more indicia affixed thereon in accordance with the exemplary method of FIG. 1.

### DETAILED DESCRIPTION

Embodiments of the present invention will now be described with reference to the accompanying drawings where like numerals correspond to like elements. Embodiments of the present invention are directed to wood products having warp orientation indicia disposed thereon, and methods for making the same. Specifically, embodiments of the present invention determine warp orientation in a wood product and then affix an indicia indicative of the warp orientation on the wood product so that end users may use the wood product in its most effective manner. Embodiments of the present invention may also determine other wood product attributes that may be indicated by the one or more indicia.

The term “warp” is used herein to refer to at least crown, also known as crook, bow, cup, and twist. The term “wood products” is used herein to refer to processed lumber (e.g.; planks, boards, and studs), veneer based wood products (e.g., plywood, laminated veneer lumber, etc.) and finger jointed lumber. The methods described herein may be practiced on any species of wood, and may be practiced with hardwoods and softwoods alike. It will be apparent to those skilled in the art that embodiments of the present invention described herein are illustrative in nature, and should not limit the scope of the present invention, as claimed.

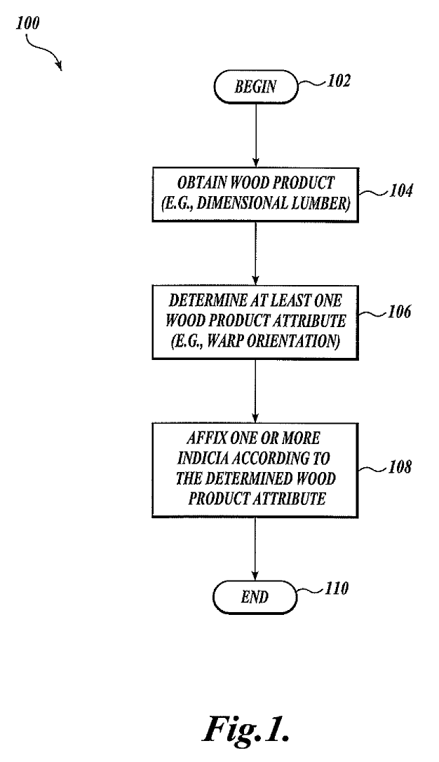

FIG. 1 is a flow chart of one exemplary method of making a wood product having warp orientation indicia, generally designated 100, in accordance with aspects of the present invention. Generally described, the method 100 identifies warp orientation of a wood product in an automated or semi-automated process, and affixes the wood product with indicia that will assist the end user, such as a framing carpenter, a finish carpenter, a trim carpenter, etc., with improved wood product application, e.g., studs, beams, joists, molding, etc, and in-service placement, e.g., location and orientation.

Generally described, the method 100 begins at block 102 and proceeds to block 104 at which a wood product is obtained. For example, a piece of dimension lumber may be selected, as well as other processed lumber. It will be appreciated that the selected wood product may have been previously graded in accordance with the American Softwood Lumber Standard. Alternatively, as will be described in detail below, the wood product that is obtained may undergo grading at a subsequent time in the process. In several embodiments, the selected wood product has at least one processed surface, e.g., planed, trimmed, etc.). In other embodiments in which stock lumber and dimension lumber is obtained, at least four surfaces have been processed, e.g., planed. Alternatively, embodiments of the present invention may obtain the piece of lumber in its rough state.

Next, at block 106, the wood product undergoes tests that determine one or more wood product attributes. For example, the orientation of warp at the time of manufacture may be measured using standard shape measurement instrumentation. As another example, the orientation of the warp that will occur once the piece of lumber is further dried, or placed in service, may be inferred from any well known tests in the art. For example, the warp orientation test may utilize near infrared spectra techniques. In other embodiments, acoustic energy techniques for testing stiffness patterns may be employed for determining warp orientation. In yet other embodiments, the warp orientation test may include measuring the trachied-effect patterns of the wood product for determining warp orientation.

One commercially available apparatus that utilizes trachied-effect measurements that may be employed in embodiments of the present invention is the GradeScan auto grader, manufactured by Lucidyne Technologies, Inc., Corvallis, Oreg. Other methods of predicting warp potential in wood products, such as lumber, that that may be practiced with embodiments of the present invention are disclosed in U.S. Pat. Nos. 6,293,152, 6,305,224 and 6,308,571, the disclosures of which are hereby incorporated by reference. A brief discussion of one method for determining warp potential in wood products will now be described. Generally described, the warp potential determination method quantifies a dimensional, such as lengthwise, shrinkage map for a selected wood product and then quantifies the warp potential in such a wood product based on the lengthwise shrinkage map.

To quantify the lengthwise shrinkage map of the wood product, several steps typically occur. First, measurements such as tracheid-effect are taken at a plurality of measuring locations along the wood product and the measurements are compiled. The tracheid-effect measurements may be taken at any interval along the wood product's width and length. Next, an empirical relationship or correlation between actual lengthwise shrinkage and tracheid-effect measurement for the wood product (i.e., loblolly pine lumber) is obtained. This correlation is typically obtained by conducting tests on a plurality of sample specimens that are representative of the wood product. For example, tracheid-effect measurements may be obtained for each specimen. Next, actual lengthwise shrinkage measurements of each specimen are obtained. This may be accomplished by measuring the specimens at an equilibrium moisture content (EMC) at a relative humidity (RH) of 90%. The specimens are then brought to an equilibrium moisture content at 20% RH and the measurements are repeated. After the tracheid-effect measurements and the actual lengthwise shrinkage are obtained for each specimen, a correlation between tracheid effect measurement and lengthwise shrinkage may be determined using well-known regression techniques, such as the least squares model.

Once the empirically determined, lengthwise shrinkage correlation is quantified, the resulting quantified correlation is utilized to convert tracheid-effect measurement patterns of the wood product into a lengthwise shrinkage map. This map can then be used to determine warp potential, such as crook, of the wood product. For example, the data comprising the lengthwise shrinkage map can be entered into a computerized finite element model (FEM) to be analyzed. The finite element model analyzes the stress and strain components of the wood product. One such finite element model that may be utilized is the DIMENS model developed by Weyerhaeuser Company, Federal Way, Wash. The finite element model simulation quantitatively determines the warp potential for the wood product.

Thus, one method of determining warp orientation includes the steps of: (1) obtaining tracheid-effect measurements at a plurality of locations along a selected wood product, such as a Loblolly pine board, and compiling those measurements to form a measurement profile; (2) correlating the tracheid-effect measurements to lengthwise shrinkage from a plurality of specimens representative of the wood product; (3) converting the measurement profile into a lengthwise shrinkage map using the empirically derived shrinkage correlation; and (4) quantitatively determining the warp potential for the wood product by analyzing the lengthwise shrinkage map with a computerized finite element model, such as the DIMENS model. For a more detailed description of this and other warp potential determination methods, please refer to U.S. Pat. Nos. 6,293,152, 6,305,224 and 6,308,571.

Additionally or alternatively, warp orientation of the wood product can be determined visually by mill operators or via automated scanning means known in the art after the wood product is processed, e.g., planed. In these embodiments that employ visual testing, it may be desirable to use kiln dried lumber.

It will be appreciated that one or more of the aforementioned techniques or others may be utilized in determining the warp orientation of the wood product. Such techniques can be appropriately chosen by those skilled in the art for its intended application. For example, acoustic measurements have been shown to provide superior results in predicting warp orientation, and the potential magnitude of the warp orientation. Therefore, the wood product may be tested with different techniques to determine whether the wood product is appropriate for an intended use, e.g., interior wall vs. exterior wall, studs, joists, molding, etc. Moreover, it will be appreciated that other tests may be conducted on the wood product simultaneously or subsequently to warp orientation testing. These tests may include but are not limited to any currently used in the wood products industry for grading lumber, for example, in accordance with the American Softwood Lumber Standard.

In one exemplary embodiment, the warp orientation tests may be conducted along one or more sections of the wood product. In several exemplary embodiments, a plurality of measurements, such as sound velocity measurements, tracheid-effect measurements, etc., associated with a plurality of measuring locations along the one or more sections of the wood product are obtained. It will be appreciated that these measurements may be lengthwise measurements, widthwise measurements, depthwise measurements, or combinations thereof and may be taken along one or more sections of the wood product or the along the entire wood product.

The results of these measurements are analyzed to determine at least warp orientation. It will be appreciated that the results of the analysis may indicate localized warp orientation for each of the sections or a generalized warp orientation of the wood product, for example, approximated by averaging the measurements taken along the wood product. The results may also indicate severity of the warp or the confidence level in the determination, e.g., low, medium, high, etc. Other wood product attributes may also be determined.

Once the testing in block 106 is complete and the one or more wood product attributes, including warp orientation, are determined, the method continues to block 108. At block 108, the wood product is appropriately affixed with indicia according to the results of the one or more tests previously conducted. The wood product may be affixed with one or more indicia along the one or more sections of the wood product. The one or more indicia may indicate to the end user one or more of the following: 1) warp type, e.g., crown, cup, twist, and/or bow; 2) warp magnitude; 3) wood product use. e.g., stud, joists, flooring, molding, etc., 4) wood product placement, e.g., exterior walls, interior walls, etc., 4) current direction of warp, 5) future direction of warp.

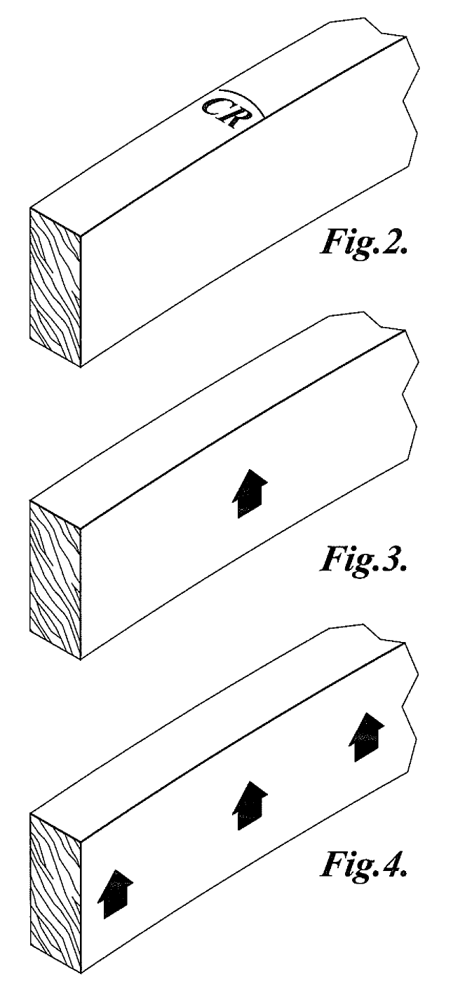

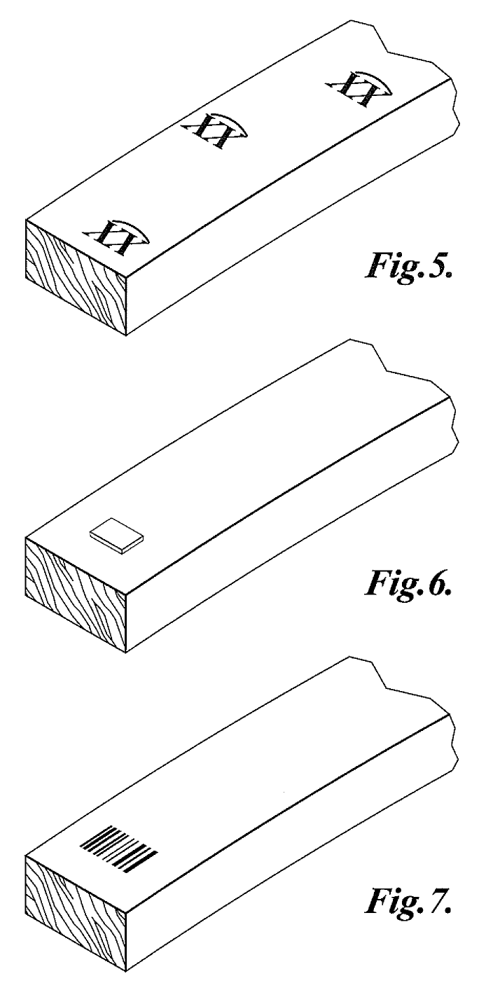

The indicia may be any symbol, letter, number, character, or combinations thereof etc., in any size or color that indicates to the end user one or more of the attributes described above. The indicia may be printed on the wood products, applied via labels, painted, etc. The indicia may be positioned on the surface of the wood product affected by the warp orientation testing or may be positioned on an associated surface. For example, a symbol, such as the letters “CR” may be affixed on a surface of the wood product that indicates that this surface will experience crowning, as shown ill the example of FIG. 2, or a symbol, such as an arrow, may be used on an associated surface, such as one orthogonal to the crowning surface, that points in the direction of crowning, as shown in the example of FIGS. 3 and 4.

It will also be appreciated that the size or color of the symbol may connote separate information, such as the magnitude, of the warp. Alternatively, it will be appreciated that the magnitude of the warp may be indicated by other symbols, such as one or more numbers, letters, or combinations thereof. Accordingly, it will be appreciated that any number of symbols, characters, letters, numbers, etc. may be used in any number of ways, including color and/r size to convey information to the end user so that the end user may more effectively and efficiently use the wood product.

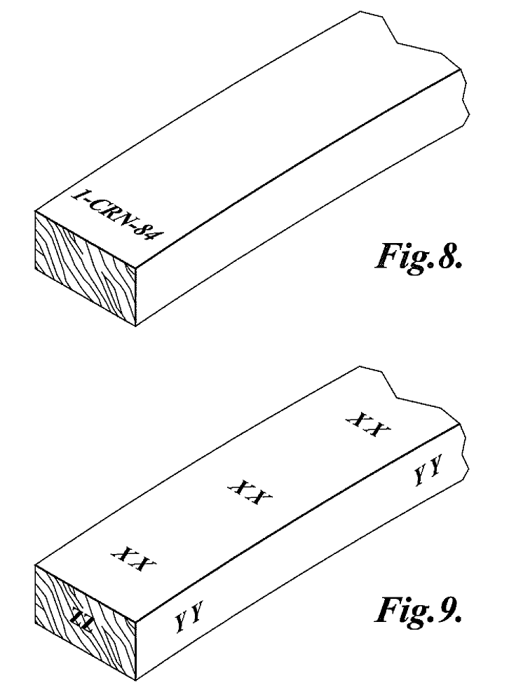

It will be appreciated that other objects may be employed to convey the attributes of the wood product described above. For example, RFID tags, bar codes, etc. may be used to convey the information related to the specified wood product to the end user, as shown in FIGS. 6 and 7, respectively. The RFID tags, bar codes, etc. can be attached to the wood product by any means known in the art. It should be appreciated that the term “indicia” as used herein should include both objects, e.g., bar codes, RFID tags, symbols, letters, characters, and numbers, etc. or any other means for conveying information regarding wood product attributes to the user.

While the preferred embodiments of the invention have been illustrated and described, it will be appreciated that various changes can be made therein without departing from the spirit and scope of the invention.

The embodiments of the invention in which an exclusive property or privilege is claimed are defined as follows:

1. A wood product, comprising:
a body having one or more sections;
one or more indicia affixed to the one or more sections of the body indicative of at least one warp orientation of the body;
wherein the one or more indicia are selected based on the results of one or more warp determining tests, the tests obtaining one or more measurements selected from a group consisting of moisture content measurement, electrical property measurement, structural property measurement, acousto-ultrasonic property measurement, light scatter or tracheid-effect measurement, grain angle measurement, shape measurement, color measurement, spectral measurement and defect maps.

2. The wood product of claim 1, wherein the one or more indicia is selected from a group consisting of a mark, an electronic tag, and a bar code.

3. The wood product of claim 2, wherein the mark is selected from a group consisting of lines, letters, numbers, shapes, symbols, characters, and combinations thereof.

4. The wood product of claim 2, wherein the size or color of the indicia may vary to indicate information regarding at least warp orientation.

5. The wood product of claim 1, wherein the wood product is lumber.

6. The wood product of claim 5, wherein the wood product is graded lumber.

7. The wood product of claim 1, further including a second indicia indicative of one or more attributes of the body other than warp orientation.

8. The wood product of claim 1, wherein the one or more measurements are widthwise measurements, lengthwise measurements, and/or depthwise measurements.

9. A method of making a wood product having a warp orientation indicia, comprising:
obtaining a wood product having one or more surfaces;
determining at least one wood product attribute associated with the wood product; and
attaching one or more indicia to at least one of the one or more surfaces, at least one of the one or more indicia indicative of warp orientation.

10. The method of claim 9, wherein the wood product is a piece of lumber.

11. The method of claim 9, wherein determining the warp orientation includes conducting one or more tests on the wood product; and
analyzing the results of the one or more tests to determine warp orientation.

12. The method of claim 11, wherein the one or more tests obtain one or more measurements selected from a group consisting of moisture content measurement, electrical property measurement, structural property measurement, acousto-ultrasonic property measurement, light scatter or tracheid-effect measurement, grain angle measurement, shape measurement, color measurement, spectral measurement and defect maps.

13. The method of claim 11, wherein the one or more measurements are widthwise measurements, lengthwise measurements, and/or depthwise measurements.

14. The method of claim 13, wherein the one or more measurements are taken along one or more sections of the wood product.

15. The method of claim 9, wherein the one or more indicia is selected from a group consisting of lines, letters, numbers, shapes, symbols, and combinations thereof.

16. The method of claim 15, wherein the size or color of the indicia may vary to indicate information regarding at least warp orientation.

17. The method of claim 9, wherein the one or more indicia is a bar code or an electronic tag.

18. A product formed by the method of claim 9.
